(19) United States
(12) Patent Application Publication
(10) Pub. No.: US 2019/0172225 A1
(43) Pub. Date: Jun. 6, 2019

(54) VEHICLE SENSOR CALIBRATION APPARATUS AND METHOD USING THE SAME

(71) Applicant: Electronics and Telecommunications Research Institute, Daejeon (KR)

(72) Inventors: Sang Heon PARK, Daejeon (KR); Jeong Dan CHOI, Daejeon (KR); Seung Jun HAN, Daejeon (KR); Jungyu KANG, Daejeon (KR); Kyoung Wook MIN, Sejong-si (KR); Kyung Bok SUNG, Daejeon (KR); Dong Jin LEE, Daejeon (KR); Yong Woo JO, Daejeon (KR)

(73) Assignee: Electronics and Telecommunications Research Institute, Daejeon (KR)

(21) Appl. No.: 16/133,158

(22) Filed: Sep. 17, 2018

(30) Foreign Application Priority Data
Dec. 4, 2017 (KR) 10-2017-0165131
May 21, 2018 (KR) 10-2018-0057800

(51) Int. Cl. G06T 7/80; G01S 7/497; G01S 17/89; G06K 9/00; G01C 21/36; G01S 17/42

(52) U.S. Cl. CPC G06T 7/80; G01S 7/4972; G01S 17/89; G01S 13/867; G01C 21/3602; G01S 17/42; G06T 2207/10004; G06K 9/00798

(57) ABSTRACT

Provided is a technology for a vehicle sensor calibration, in which a vehicle sensor calibration apparatus according to an embodiment includes a sensor device installed inside a calibration room that is a space in which a vehicle having a vehicle sensor mounted thereon is positioned, and configured to obtain basic position information and basic orientation information of the vehicle, a calibration execution module installed in the vehicle and configured to execute calibration on the vehicle sensor on the basis of information received from the outside, and a control module configured to generate calibration position information and calibration orientation information for calibration of the vehicle by analyzing the basic position information and the basic orientation information obtained by the sensor device.

### CROSS-REFERENCE TO RELATED APPLICATION

This application claims priority to and the benefit of Korean Patent Application No. 10-2017-0165131, filed on Dec. 4, 2017, and Korean Patent Application No. 10-2018-0057800, filed on May 21, 2018 the disclosure of which is incorporated herein by reference in its entirety.

### BACKGROUND

### 1. Field of the Invention

The present invention relates to a technology for vehicle sensor calibration, and more specifically, to a vehicle sensor calibration apparatus capable of accurately performing calibration on vehicle sensors mounted on a vehicle in a state in which the vehicle sensors are mounted on the vehicle, and a method using the same.

### 2. Discussion of Related Art

The statement in this section merely provides background information related to embodiments of the present invention and does not necessarily constitute the related art.

Recently, studies on autonomous driving have been actively conducted.

With regard to map data of the autonomous driving, a local dynamic map (LDM) is divided into four types from Type 1 to Type 4 according to dynamic characteristics of information. Type 1 information, which is ‘static’ information, is map information related to a road, a building, and the like, Type 2 information, which is ‘quasi-static’ information, is map information related to a landmark, a traffic sign, and the like, Type 3 information, which is ‘dynamic’ information, is map information related to a traffic jam, a traffic light, a traffic accident, a construction section, a road condition, and the like, and Type 4 information, which is ‘highly dynamic’ information, is information related to nearby vehicles, pedestrians, and the like.

The LDM is significantly important in relation to intelligent transport system (ITS), but in order make the LDM available for autonomous driving, it is considered that the LDM is required to deal with more precise information.

Meanwhile, for autonomous driving, there is a need to precisely recognize external environments through sensors or the like and determine driving conditions, such as driving direction, speed, and the like, on the basis of the recognized information.

Radars and the like are used as sensors for external environment recognition, but the use of a vision sensor has become more active so that a larger amount of information is able to be recognized. The vision sensor is also drawing attention in terms of being relatively cheaper than other sensors. Accordingly, there has been a remarkable development on technologies of vehicle external environment recognition based on pattern recognition and image processing, which is expected to greatly contribute to autonomous driving.

Sensors need to be subject to an initial calibration when mounted on a vehicle. Generally, calibration is performed by moving a vehicle on a floor in which a pattern of a chess board is marked, and in this case, the position and posture of the vehicle need to be properly adjusted. The process of moving the vehicle and adjusting the position and posture for calibration is not only time consuming but also cumbersome, and thus needs to be improved.

The foregoing is intended merely to aid in the understanding of the background of the present invention, and is not intended to mean that the present invention falls within the purview of the related art that is already known to those skilled in the art.

### SUMMARY OF THE INVENTION

Prior to use, sensors need to be subject to an initial calibration process in a state of being installed in a vehicle, and conventionally, calibration has been performed by moving a vehicle several times for the vehicle to match a pattern previously drawn on the floor, that is, a pattern matching process as described above, or by laying a carpet-type pattern around the vehicle in a direction in which the vehicle is parked.

However, according to the above described method, preparation work for calibration of one vehicle becomes long and the calibration work is delayed.

The present invention is directed to providing a vehicle sensor calibration apparatus capable of accurately performing calibration on vehicle sensors mounted on a vehicle in a state in which the vehicle sensors are mounted on the vehicle, and a method using the same.

The technical objectives of the present invention are not limited to the above disclosure, and other objectives may become apparent to those of ordinary skill in the art based on the following descriptions.

One aspect of the present invention provides a vehicle sensor calibration apparatus including: a sensor device installed inside a calibration room that is a space in which a vehicle having a vehicle sensor mounted thereon is positioned, and configured to obtain basic position information and basic orientation information of the vehicle; a calibration execution module installed in the vehicle and configured to execute calibration on the vehicle sensor on the basis of information received from the outside; and a control module configured to generate calibration position information and calibration orientation information for calibration of the vehicle by analyzing the basic position information and the basic orientation information obtained by the sensor device.

The calibration execution module may be configured to execute calibration on the vehicle sensor on the basis of the calibration position information and the calibration orientation information.

The sensor device may include at least one of a laser scanner and a vision sensor that is installed inside the calibration room.

The control module may be configured to generate the calibration position information and the calibration orientation information by an analysis of comparing the basic position information and the basic orientation information with a predetermined calibration pattern.

The vehicle sensor calibration apparatus may further include a pattern display device configured to project a calibration pattern image provided from the outside, wherein a camera configured to image a state in which the calibration pattern image is aligned with the vehicle may be installed in the vehicle, and the calibration execution module may execute calibration on the vehicle sensor on the basis of image information provided from the camera.

The control module may be configured to generate the calibration pattern image aligned with the vehicle according to the calibration position information and the calibration orientation information, and provide the generated calibration pattern image.

The pattern display device may include at least one of a display panel installed on a floor of the calibration room to project the calibration pattern image and a projector installed on a ceiling of the calibration room to project the calibration pattern image onto the floor of the calibration room.

The pattern display device may include a projector installed so as to be moveable in vertical and lateral directions and rotatable, and the control module may allow the calibration pattern image to be aligned with the vehicle by moving or rotating the project according to the calibration position information and the calibration orientation information.

Another aspect of the present invention provides a vehicle sensor calibration method including: obtaining basic position information and basic orientation information of a vehicle on which a vehicle sensor is mounted, when the vehicle is positioned inside a calibration room; generating calibration position information and calibration orientation information for calibration of the vehicle by analyzing the basic position information and the basic orientation information; and executing calibration on the vehicle sensor on the basis of the calibration position information and the calibration orientation information.

The obtaining may be performed by any one of a laser scanner and a vision sensor that is installed inside the calibration room.

The generating may be achieved through an analysis of comparing the basic position information and the basic orientation information with a predetermined calibration pattern.

Another aspect of the present invention provides a vehicle sensor calibration method including: obtaining basic position information and basic orientation information of a vehicle on which a vehicle sensor is mounted, when the vehicle is positioned inside a calibration room; generating calibration position information and calibration orientation information for calibration of the vehicle by analyzing the basic position information and the basic orientation information; projecting a calibration pattern image that is aligned with the vehicle onto a floor of the calibration room according to the calibration position information and the calibration orientation information; capturing an image in which the calibration pattern image is aligned with the vehicle; and executing calibration on the vehicle sensor on the basis of the image obtained in the capturing.

The obtaining may be performed by any one of a laser scanner and a vision sensor that is installed inside the calibration room.

The generating may be achieved through an analysis of comparing the basic position information and the basic orientation information with a predetermined calibration pattern.

The projecting may include determining an angle of deflection of the vehicle with respect to a reference direction on the basis of the calibration direction information, and projecting a calibration pattern image on which the determined angle of misalignment is reflected.

The projecting may include projecting the calibration pattern image aligned with the vehicle onto the floor of the calibration room using a display panel installed on the floor of the calibration room.

The projecting may include projecting the calibration pattern image aligned with the vehicle onto the floor of the calibration room using a projector installed on a ceiling of the calibration room.

The projecting may include projecting the calibration pattern image aligned with the vehicle onto the floor of the calibration room by controlling a projector installed on a ceiling of the calibration room so as to be moveable in front-rear and lateral directions and rotatable.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating the inside of a calibration room of a vehicle sensor calibration apparatus according to a first embodiment of the present invention;

FIG. 2 is a block diagram illustrating the vehicle sensor calibration apparatus according to the first embodiment of the present invention:

FIG. 3 is a view illustrating an example in which a vehicle is detected by a laser scanner in the vehicle sensor calibration apparatus according to the first embodiment of the present invention;

FIG. 4 is a view illustrating an example in which a vehicle is detected by a vision sensor in the vehicle sensor calibration apparatus according to the first embodiment of the present invention;

FIG. 5 is a view illustrating the inside of a calibration room of a vehicle sensor calibration apparatus according to a second embodiment of the present invention;

FIG. 6A is a block diagram illustrating a sensor device, a control module and a pattern display device of the vehicle sensor calibration apparatus according to the second embodiment of the present invention and FIG. 6B is block diagram illustrating component of a vehicle of the vehicle sensor calibration apparatus according to the second embodiment of the present invention;

FIG. 7A is a view illustrating an example in which a vehicle is positioned in a misaligned state in the calibration room of the vehicle sensor calibration apparatus according to the second embodiment of the present invention;

FIG. 7B is a view illustrating an example in which a calibration pattern image aligned with a vehicle is projected, in the vehicle sensor calibration apparatus according to the second embodiment of the present invention;

FIG. 8 is a flowchart showing a vehicle sensor calibration method using a vehicle sensor calibration apparatus according to an exemplary embodiment of the present invention:

FIG. 9 is a flowchart showing a vehicle sensor calibration method using the vehicle sensor calibration apparatus according to the first embodiment of the present invention; and

FIG. 10 is a flowchart showing a vehicle sensor calibration method using the vehicle sensor calibration apparatus according to the second embodiment of the present invention.

### DETAILED DESCRIPTION OF EXEMPLARY EMBODIMENTS

As specific structural or functional descriptions for embodiments according to the present invention disclosed herein are merely exemplified for purposes of describing the embodiments according to the present invention, the embodiments according to the present invention may be embodied in various forms but are not limited to the embodiments described herein.

While the invention is susceptible to various modifications and alternative forms, specific embodiments thereof are shown by way of example in the drawings and will herein be described in detail. However, it should be understood that there is no intent to limit the invention to the particular forms disclosed, rather the invention is to cover all modifications, equivalents, and alternatives falling within the spirit and scope of the invention. Like numbers refer to like elements throughout the description of the figures.

It should be understood that, although the terms first, second, etc. may be used herein to describe various elements, these elements are not limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It should be understood that when an element is referred to as being “connected” or “coupled” to another element, the element can be directly connected or coupled to another element or intervening elements may be present. Conversely, when an element is referred to as being “directly connected” or “directly coupled” to another element, there are no intervening elements present. Other words used to describe a relationship between elements should be interpreted in a like fashion (i.e., “between” versus “directly between,” “adjacent” versus “directly adjacent,” etc.).

The terminology used herein is for the purpose of describing particular embodiments only and is not intended to limit the invention. As used herein, the singular forms “a,” “an,” and “the” are intended to include the plural forms as well, unless the context clearly indicates otherwise. It should be further understood that the terms “comprises,” “comprising,” “includes,” and/or “including,” when used herein, specify the presence of stated features, integers, steps, operations, elements, components and/or groups thereof, and do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

It should also be noted that in some alternative implementations, functions/actions noted in blocks may occur out of the order noted in flowcharts. For example, two blocks shown in succession may in fact be executed substantially concurrently or the blocks may sometimes be executed in a reverse order depending upon the functionality/actions involved.

Hereinafter, a vehicle sensor calibration apparatus and a method using the same suggested in the present invention will be described in detail with reference to the accompanying drawings.

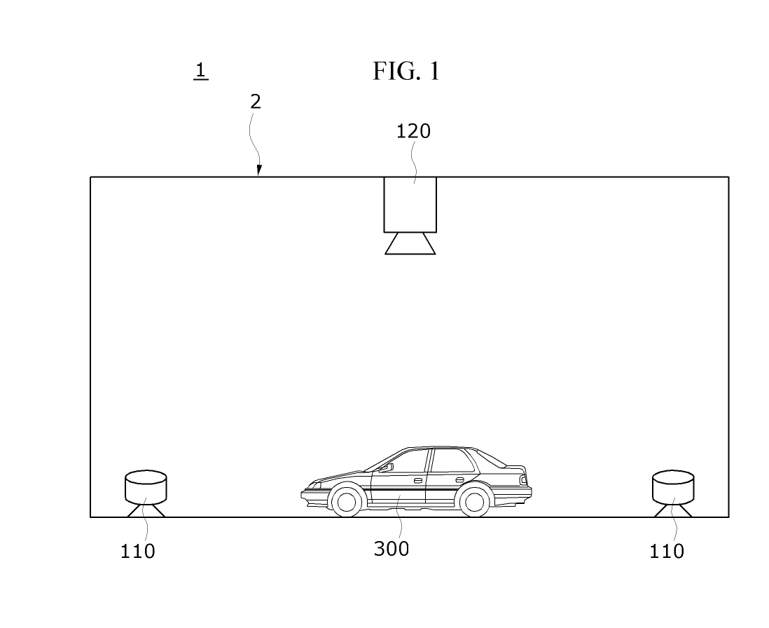

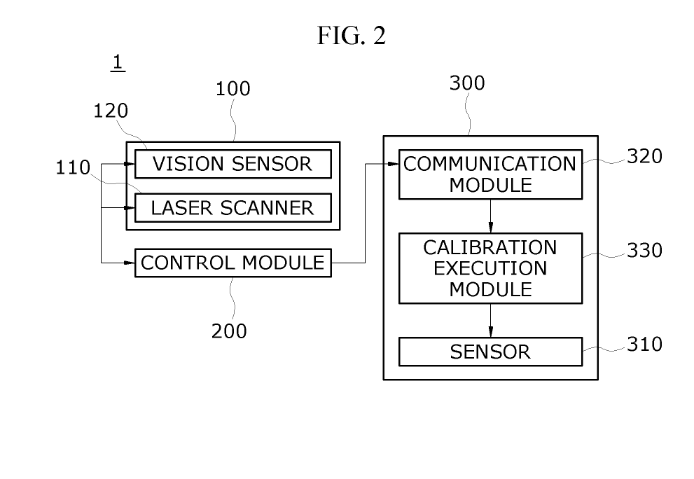

FIG. 1 is a view illustrating the inside of a calibration room of a vehicle sensor calibration apparatus according to a first embodiment of the present invention, and FIG. 2 is a block diagram illustrating the vehicle sensor calibration apparatus according to the first embodiment of the present invention.

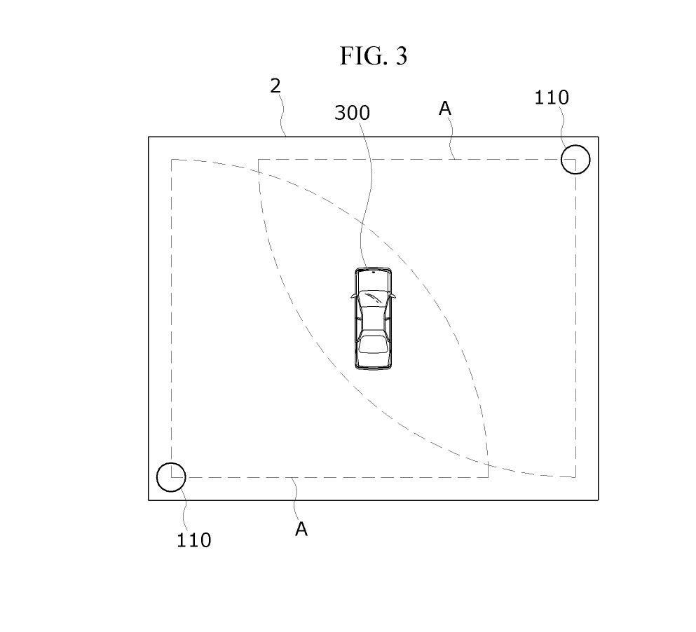

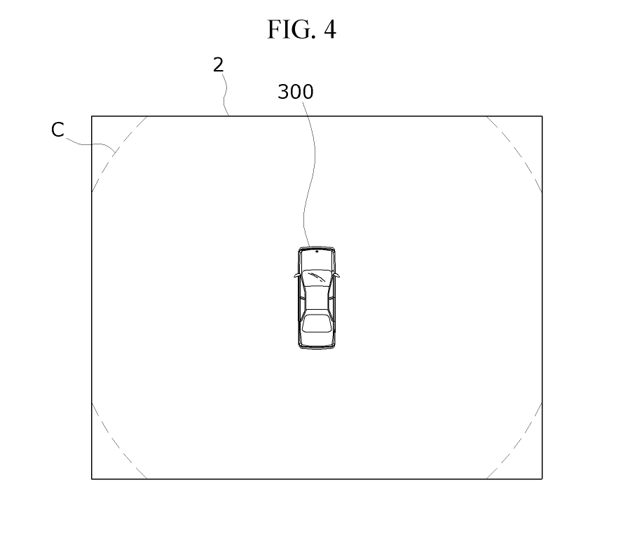

FIG. 3 is a view illustrating an example in which a vehicle is detected by a laser scanner in the vehicle sensor calibration apparatus according to the first embodiment of the present invention, and FIG. 4 is a view illustrating an example in which a vehicle is detected by a vision sensor in the vehicle sensor calibration apparatus according to the first embodiment of the present invention.

Referring to FIGS. 1 to 4, a vehicle sensor calibration apparatus 1 according to the first embodiment of the present invention includes a sensor device 100 installed inside a calibration room 2 that is a space in which a vehicle 300 having a calibration target sensor mounted thereon is positioned.

In addition, the vehicle sensor calibration apparatus 1 includes a control module 200 installed inside or outside the calibration room 2.

On a floor of the calibration room 2, a pattern for calibration (‘a calibration pattern’) used to align the vehicle 300 and detect a position and orientation of the vehicle 300 may be marked.

The sensor device 100 is an element used to detect the vehicle 300 positioned inside the calibration room 2, and may include at least one of a laser scanner 110 and a vision sensor 120. However, the construction of the sensor device 100 is not limited to the embodiment.

For example, the laser scanner 110 may be installed at a sidewall of the calibration room 2 or adjacent to the sidewall of the calibration room 2, and the vision sensor 120 may be installed at a central portion of the ceiling of the calibration room 2. However, the installation position of the laser scanner 110 and the vision sensor 120 is not limited to the embodiment, and may be any position as long as the vehicle 300 is easily detected.

In particular, the sensor device 100 obtains position information and orientation information of the vehicle 300 and provides the control module 200 with basic position information and basic orientation information of the vehicle 300.

The basic position information of the vehicle 300 provided by the sensor device 100 is information indicating a location in which the vehicle 300 is positioned inside the calibration room 2.

The basic orientation information of the vehicle 300 provided by the sensor device 100 is information indicating a current direction in which the vehicle 300 faces.

Referring to FIG. 3, the laser scanner 110, while installed at a predetermined position (e.g., a front right side and a rear left side with respect to a forward direction of the vehicle), may detect the position and orientation of the vehicle 300 by scanning a predetermined detection range (area A and area B).

Referring to FIG. 4, the vision sensor 120, while installed at a predetermined position (e.g., a central portion of the ceiling), may detect the position and orientation of the vehicle 300 by imaging a predetermined detection range (area C).

In this case, the vision sensor 120 may detect the position and orientation of the vehicle 300 by identifying an angle between the sidewall of the calibration room 2 and a side surface of the vehicle 300 and distances between front, rear, left and right sides of the vehicle 3 and wall surfaces inside the calibration room 2.

The control module 200 receives basic information (e.g., basic position information and basic orientation information) of the vehicle 300 from the sensor device 100, performs analysis by comparing the received basic information with a calibration pattern, and generates a position and an orientation of the vehicle 300 (‘a calibration position’ and ‘a calibration orientation’) as previously programmed.

The control module 200 provides the vehicle 300 with calibration position information and calibration orientation information of the vehicle 300.

The calibration position information of the vehicle 300 provided by the control module 200 is information indicating a location in which the vehicle 300 is positioned inside a calibration pattern image.

The calibration orientation information of the vehicle 300 provided by the control module 200 is information related to an angle of a current direction in which the vehicle 300 faces with respect to a reference direction (e.g., a direction in which the vehicle, when normally positioned, faces).

That is, the degree to which the vehicle 300 is misaligned from the reference direction is identified through the calibration orientation information.

In addition, the control module 200 may perform control (e.g., operation-on (ON)/operation-off (OFF)) on the sensor device 100 as previously programmed.

To this end, the control module 200 may include hardware including at least one memory that stores algorithms (programs) needed to execute functions and stores a result of execution of operation, and at least one processor configured to execute functions.

On the vehicle 300, a calibration target sensor 310, a communication module 320 for communication with an external device (e.g., a control module 200), and a calibration execution module 330 executing calibration on the calibration target sensor 310 on the basis of information detected by the sensor device 100 are installed.

In this case, the calibration execution module 330 may include hardware including at least one memory that stores algorithms (programs) needed to execute functions and stores a result of execution of operation, and at least one processor configured to execute functions.

The calibration execution module 330 executes calibration on the calibration target sensor 310 on the basis of calibration position information and calibration orientation information of the vehicle 300 provided from the control module 200.

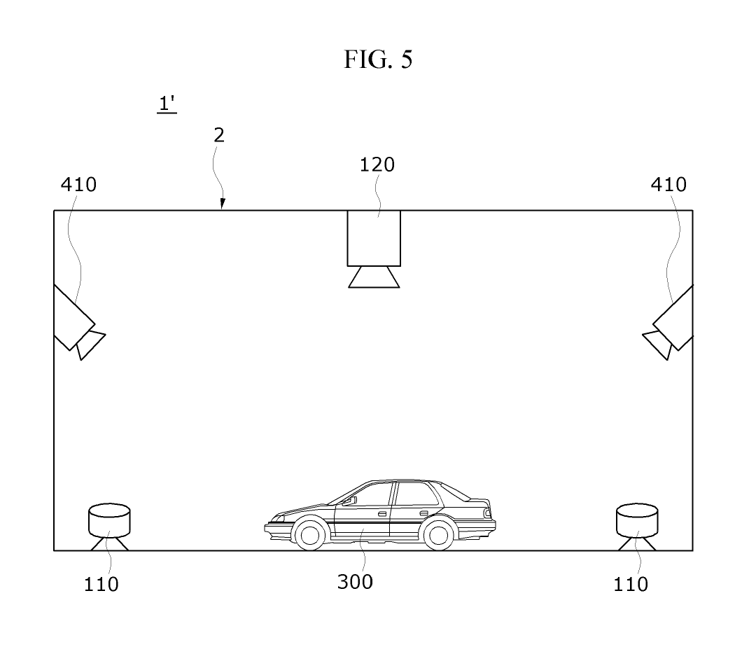

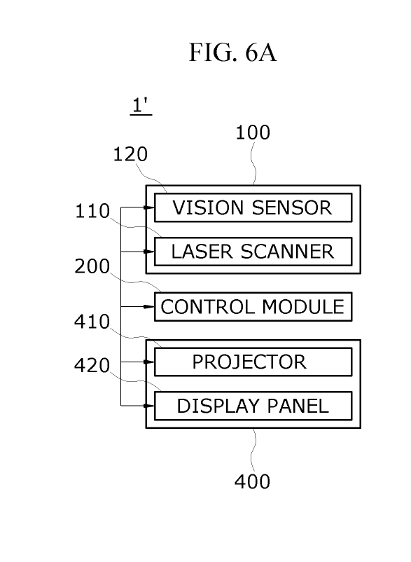

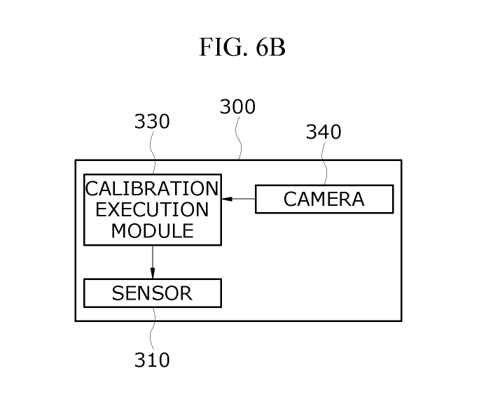

FIG. 5 is a view illustrating the inside of a calibration room of a vehicle sensor calibration apparatus according to a second embodiment of the present invention, FIG. 6A is a block diagram illustrating a sensor device, a control module and a pattern display device of the vehicle sensor calibration apparatus according to the second embodiment of the present invention, and FIG. 6B is block diagram illustrating component of a vehicle of the vehicle sensor calibration apparatus according to the second embodiment of the present invention;

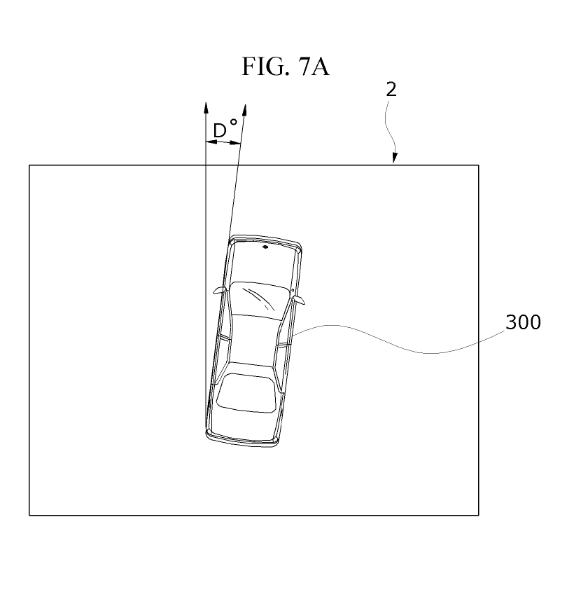

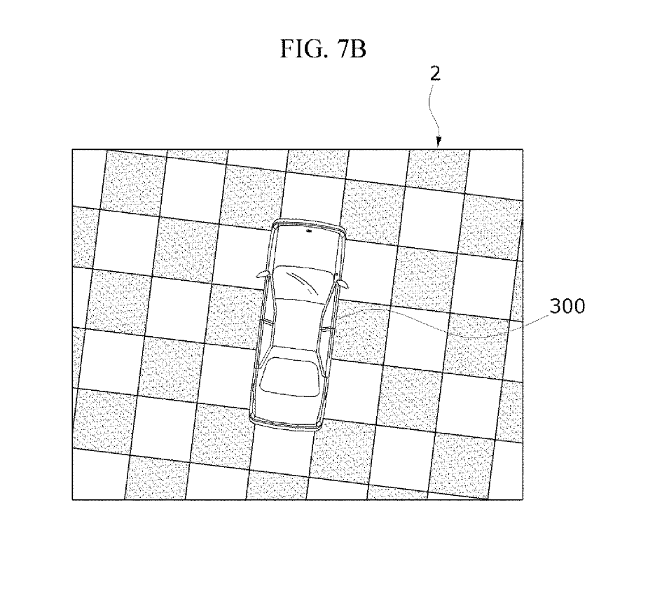

FIG. 7A is a view illustrating an example in which a vehicle is positioned in a misaligned state in the calibration room of the vehicle sensor calibration apparatus according to the second embodiment of the present invention, and FIG. 7B is a view illustrating an example in which a calibration pattern image aligned with the vehicle is projected, in the vehicle sensor calibration apparatus according to the second embodiment of the present invention.

In the following description of a vehicle sensor calibration apparatus 1′ according to the second embodiment of the present invention with reference to FIGS. 5 and 7B, the same reference numerals will be assigned to the elements according to the second embodiment identical to the elements according to the first embodiment, and only necessary parts will be described.

The vehicle sensor calibration apparatus 1′ according to the second embodiment of the present invention includes a sensor device 100 installed inside a calibration room 2 that is a space in which the vehicle 300 having the calibration target sensor 310 mounted thereon is positioned, and a pattern display device 400.

In addition, the vehicle sensor calibration apparatus 1′ includes a control module 200 installed inside or outside the calibration room 2.

Since the sensor device 100 is an element identical to the sensor device 100 of the vehicle sensor calibration apparatus 1 according to the first embodiment of the present invention, detailed descriptions thereof will be omitted.

As described above, the sensor device 100 includes at least one of a laser scanner 110 and a vision sensor 120, and provides the control module 200 with basic position information and basic orientation information of the vehicle 300 inside the calibration room 2.

The control module 200 may perform control (e.g., operation-on (ON)/operation-off (OFF)) on the sensor device 100 as previously programmed.

In addition, the control module 200 may control the pattern display device 400 to project a calibration pattern image according to calibration position information and calibration orientation information, which is generated through analysis of comparing basic information of the vehicle 300 (the basic position information and the basic orientation information) received from the sensor device 100 with a calibration pattern.

In this case, the control module 200 allows a calibration pattern image, which is aligned with the vehicle 300, to be projected through the pattern display device 400 according to the calibration position information and the calibration orientation information of the vehicle 300.

To this end, the control module 200 may include hardware including at least one memory that stores algorithms (programs) needed to execute functions and stores a result of execution of operation, and at least one processor configured to execute functions.

On the vehicle 300, a calibration target sensor 310, a camera 340 configured to image a predetermined area inside the calibration room 2, and a calibration execution module 330 that executes calibration on the calibration target sensor 310 on the basis of image information from the camera 340 are installed.

To this end, the calibration execution module 330 may include hardware including at least one memory that stores algorithms (programs) needed to execute functions and stores a result of execution of operation, and at least one processor configured to execute functions.

In particular, the camera 340 obtains an image of a state in which the calibration pattern image projected from the pattern display device 400 is aligned with the vehicle 300, and provides the calibration execution module 330 with the obtained image.

The calibration execution module 330 executes calibration on the calibration target sensor 310 on the basis of image information from the camera 340.

For example, the calibration execution module 330 may detect corners of a calibration pattern through analysis of the image information from the camera 340, and execute calibration on the calibration target sensor 310 using the detected corners.

The pattern display device 400 is an element used to project a calibration pattern image onto a floor of the calibration room 2, and may include at least one of a projector 410 and a display panel 420. However, the construction of the pattern display device 400 is not limited to the embodiment.

In this case, the pattern display device 400 projects a calibration pattern image according to control of the control module 200.

The projector 410 is installed at a predetermined position (e.g., a sidewall inside the calibration room 2) to project a calibration pattern image onto the floor of the calibration room 2.

The projector 410 may be implemented to be moveable in front-rear and lateral directions and rotatable.

The display panel 420 is installed on the floor inside the calibration room 2 to project a calibration pattern image.

That is, the pattern display device 400 may include at least one of the projector 410 to project a calibration pattern image onto the floor inside the calibration room 2 and the display panel 420 installed on the floor of the calibration room 2 to project a calibration pattern image.

When the vehicle 300 is parked in a state of being misaligned by a predetermined angle (e.g., D°) with respect to a reference direction in the calibration room 2 as shown in FIG. 7A, the laser scanner 110 or the vision sensor 120 obtains basic position information and basic orientation information of the vehicle 300 and provides the control module 200 with the obtained basic position information and basic orientation information.

Then, the control module 200 generates calibration position information and calibration orientation information on the basis of the basic position information and basic orientation information of the vehicle 300 received from the laser scanner 110 or the vision sensor 120, and controls the pattern display device 400 according to the calibration position information and the calibration orientation information, such that the pattern display device 400 projects a calibration pattern image aligned with the vehicle 300 onto the floor of the calibration room 2 as shown in FIG. 7B.

For example, the control module 200 may analyze information from the sensor device 100, identify that the vehicle 300 is parked in a state of being misaligned by a predetermined angle D° with respect to the reference direction, convert a predetermined calibration pattern image into an image misaligned by the predetermined angle D°, and provide the projector 410 or the display panel 420 with the calibration pattern image converted with the predetermined angle.

For another example, the control module 200 may analyze information from the laser scanner 110 or the vision sensor 120, and physically move or rotate the projector 410 implemented so as to be movable in front-rear and lateral directions and rotatable, so that a calibration pattern image that matches with the position and orientation of the vehicle 300 is projected onto the floor of the calibration room 2.

The exemplary embodiment of the present invention has been described such that the elements of the vehicle sensor calibration apparatus and the functions thereof are subdivided into the first embodiment and the second embodiment.

Although the elements according to the first embodiment have been described independent of the elements according to the second embodiment, the elements according to the first and second embodiments may be merged.

Hereinafter, a vehicle sensor calibration method using a vehicle calibration apparatus according to an exemplary embodiment of the present invention will be described.

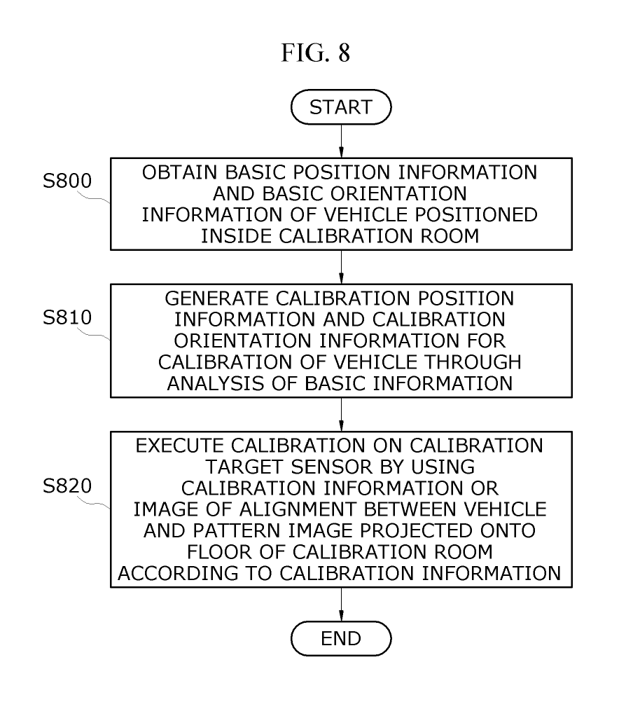

FIG. 8 is a flowchart showing a vehicle sensor calibration method using a vehicle sensor calibration apparatus according to an exemplary embodiment of the present invention.

Respective operations according to the vehicle sensor calibration method shown in FIG. 8 may be performed by the vehicle sensor calibration apparatus 1 or 1′ described with reference to FIGS. 1 to 7B.

Referring to FIG. 8, basic position information and basic orientation information of the vehicle 300 positioned inside the calibration room 2 are obtained by the sensor device 100 (S800).

In operation S800, the sensor device 100 may include at least one of the laser scanner 110 and the vision sensor 120 installed inside the calibration room 2.

In operation S800, the basic position information is information indicating a location in which the vehicle 300 is positioned inside the calibration room 2, and the basic orientation information is information indicating a current direction in which the vehicle 300 faces.

After operation S800, calibration information for calibration of the vehicle 300 (calibration position information and calibration orientation information) is generated through analysis of the detected basic information (the basic position information and the basic orientation information) by the control module 200 (S810).

In operation S810, the generation of the calibration information is achieved through analysis of comparing the basic information (the basic position information and the basic orientation information) with a calibration pattern.

In operation S810, the calibration position information is information indicating a location in which the vehicle 300 is positioned inside the calibration pattern, and the calibration orientation information is information related to an angle of a current direction in which the vehicle 300 faces with respect to a reference direction (e.g., a direction in which the vehicle, when normally positioned, faces).

After operation S810, by using the generated calibration information (the calibration position information and the calibration orientation information) or using an image of a state in which a calibration pattern image projected onto the floor of the calibration room 2 according to the generated calibration information is aligned with the vehicle, the calibration execution module 330 executes calibration on the calibration target sensor 310 (S820).

Hereinafter, a vehicle sensor calibration method using a vehicle sensor calibration apparatus according to the first embodiment of the present invention will be described.

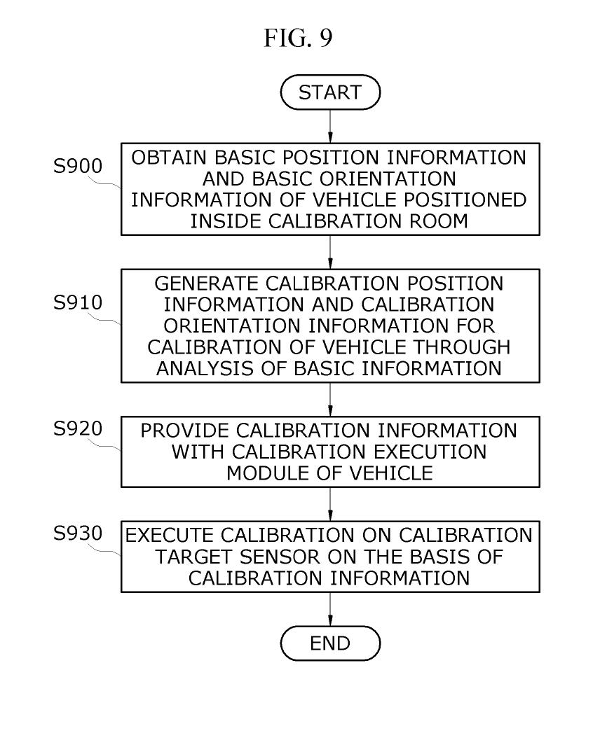

FIG. 9 is a flowchart showing a vehicle sensor calibration method using the vehicle sensor calibration apparatus according to the first embodiment of the present invention.

Respective operations shown in FIG. 9 may be performed by the vehicle sensor calibration apparatus 1 according to the first embodiment.

First, basic position information and basic orientation information of the vehicle 300 positioned inside the calibration room 2 are obtained by the sensor device 100 (S900).

In operation S900, the sensor device 100 may include at least one of the laser scanner 110 and the vision sensor 120 installed inside the calibration room 2.

In operation S900, the basic position information is information indicating a location in which the vehicle 300 is positioned inside the calibration room 2, and the basic orientation information is information indicating a current direction in which the vehicle 300 faces.

After operation S900, calibration information for calibration of the vehicle 300 (calibration position information and calibration orientation information) is generated through analysis of the obtained basic information (the basic position information and the basic orientation information) by the control module 200 (S910).

In operation S910, the generation of the calibration information may be achieved through analysis of comparing the basic information (the basic position information and the basic orientation information) with a calibration pattern.

In operation S910, the calibration position information is information indicating a location in which the vehicle 300 is positioned inside the calibration pattern, and the calibration orientation information is information related to an angle of a current direction in which the vehicle 300 faces with respect to a reference direction (e.g., a direction in which the vehicle, when normally positioned, faces).

After operation S910, the control module 200 provides the generated calibration information (the calibration position information and the calibration orientation information) to the calibration execution module 330 of the vehicle 300 (S920).

After operation S920, the calibration execution module 330 executes calibration on the calibration target sensor 310 on the basis of the calibration information (S930).

Hereinafter, a vehicle sensor calibration method using a vehicle sensor calibration apparatus according to the second embodiment of the present invention will be described.

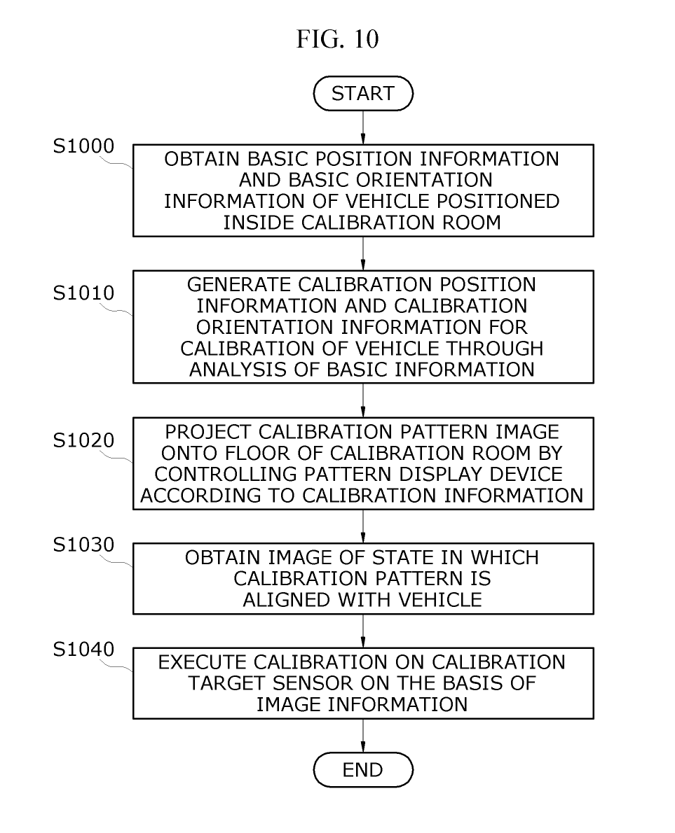

FIG. 10 is a flowchart showing a vehicle sensor calibration method using the vehicle sensor calibration apparatus according to the second embodiment of the present invention.

Respective operations shown in FIG. 10 may be performed by the vehicle sensor calibration apparatus 1′ according to the second embodiment.

First, basic position information and basic orientation information of the vehicle 300 positioned inside the calibration room 2 are obtained by the sensor device 100 (S1000).

In operation S1000, the sensor device 100 may include at least one of the laser scanner 110 and the vision sensor 120 installed inside the calibration room 2.

In operation S1000, the basic position information is information indicating a location in which the vehicle 300 is positioned inside the calibration room 2, and the basic orientation information is information indicating a current direction in which the vehicle 300 faces.

After operation S1000, calibration information for calibration of the vehicle 300 (calibration position information and calibration orientation information) is generated through analysis of the obtained basic information (the basic position information and the basic orientation information) by the control module 200 (S1010).

In operation S1010, the generation of the calibration information may be achieved through analysis of comparing the basic information (the basic position information and the basic orientation information) with a calibration pattern.

In operation S1010, the calibration position information is information indicating a location in which the vehicle 300 is positioned inside the calibration pattern, and the calibration orientation information is information related to an angle of a current direction in which the vehicle 300 faces with respect to a reference direction (e.g., a direction in which the vehicle, when normally positioned, faces).

After operation S1010, the control module 200 controls the pattern display device 400 according to the generated calibration information such that the pattern display device 400 projects a calibration pattern image onto the floor of the calibration room 2 (S1020).

In operation S1020, the control module 200 may determine the angle at which the vehicle is misaligned with respect to the reference direction on the basis of the calibration direction information, and project a calibration pattern image on which the determined angle of misalignment is reflected onto the floor of the calibration room 2 through the pattern display device 400.

In operation S1020, the control module 200 may provide the projector 410 installed at a wall inside the calibration room 2 with the calibration pattern image on which the angle of misalignment is reflected such that the projector 410 projects the calibration pattern image.

In operation S1020, the control module 200 may provide the display panel 420 installed at the bottom inside the calibration room 2 with the calibration pattern image on which the angle of misalignment is reflected such that the display panel 420 projects the calibration pattern image on which the angle of misalignment is reflected.

In operation S1020, the control module 200 may move or rotate the projector 410, which is movably or rotatably installed at the wall inside the calibration room 2, to reflect the angle of misalignment, such that the calibration pattern image on which the angle of misalignment is reflected is projected.

After operation S1020, the camera 340 mounted on the vehicle 300 obtains an image of a state in which the calibration pattern is aligned with the vehicle (S1030).

The image obtained by the camera 340 in operation S1030 is provided to the calibration execution module 330 inside the vehicle 300.

After operation S1030, the calibration execution module 330 executes calibration on the calibration target sensor 310 on the basis of image information from the camera 340 (S1040).

In the descriptions above, although all of the components of the embodiments of the present invention may have been described as assembled or operatively connected as a unit, the present invention is not intended to limit itself to such embodiments. Rather, within the objective scope of the present invention, the respective components may be selectively and operatively combined in any numbers. Also, every one of the components may be implemented by itself in hardware while the respective ones can be combined in part or as a whole selectively and implemented in a computer program having program modules for executing functions of the hardware equivalents in part or whole. The computer program may be stored in computer readable media, such as a Universal Serial Bus (USB) memory, a compact disc (CD), a flash memory, etc., which is read and executed by a computer to realize the embodiments of the present invention. For the computer readable media, the candidates include magnetic recording media, optical recording media, and carrier wave media.

As is apparent from the above, after a vehicle is parked, a pattern is formed at the accurate position and calibration is performed, or the position and posture of the vehicle with respect to a previously formed pattern are sensed and the information is allowed to be used for a calibration process, so that calibration can be rapidly achieved in comparison to the conventional technology, and thus calibration for one vehicle can be performed at a highly fast speed.

Although the vehicle sensor calibration apparatus and method according to the present invention have been described with reference to the embodiments, those skilled in the art should appreciate that various modifications, changes, and substitutions thereto are possible without departing from the scope and spirit of the invention.

Therefore, the exemplary embodiments disclosed in the present invention and the accompanying drawings are intended to illustrate and not limit the technical spirit of the present invention. The scope of the invention it set forth in the following claims rather than the above specification, and it is intended that the present invention covers all modifications provided they come within the scope of the appended claims and their equivalents.

What is claimed is:

1. A vehicle sensor calibration apparatus comprising:
a sensor device installed inside a calibration room that is a space in which a vehicle having a vehicle sensor mounted thereon is positioned, and configured to obtain basic position information and basic orientation information of the vehicle;
a calibration execution module installed in the vehicle and configured to execute calibration on the vehicle sensor on the basis of information received from the outside; and
a control module configured to generate calibration position information and calibration orientation information for calibration of the vehicle by analyzing the basic position information and the basic orientation information obtained by the sensor device.

2. The vehicle sensor calibration apparatus of claim 1, wherein the calibration execution module is configured to execute calibration on the vehicle sensor on the basis of the calibration position information and the calibration orientation information.

3. The vehicle sensor calibration apparatus of claim 1, wherein the sensor device includes at least one of a laser scanner and a vision sensor that is installed inside the calibration room.

4. The vehicle sensor calibration apparatus of claim 1, wherein the control module is configured to generate the calibration position information and the calibration orientation information by an analysis of comparing the basic position information and the basic orientation information with a predetermined calibration pattern.

5. The vehicle sensor calibration apparatus of claim 1, further comprising a pattern display device configured to project a calibration pattern image provided from the outside,
wherein a camera configured to image a state in which the calibration pattern image is aligned with the vehicle is installed in the vehicle, and
the calibration execution module executes calibration on the vehicle sensor on the basis of image information provided from the camera.

6. The vehicle sensor calibration apparatus of claim 5, wherein the control module is configured to generate the calibration pattern image aligned with the vehicle according to the calibration position information and the calibration orientation information, and provide the generated calibration pattern image.

7. The vehicle sensor calibration apparatus of claim 5, wherein the pattern display device includes at least one of a display panel installed on a floor of the calibration room to project the calibration pattern image and a projector installed on a ceiling of the calibration room to project the calibration pattern image onto the floor of the calibration room.

8. The vehicle sensor calibration apparatus of claim 5, wherein the pattern display device includes a projector installed so as to be moveable in vertical and lateral directions and rotatable, and
the control module allows the calibration pattern image to be aligned with the vehicle by moving or rotating the project according to the calibration position information and the calibration orientation information.

9. A vehicle sensor calibration method comprising:
obtaining basic position information and basic orientation information of a vehicle on which a vehicle sensor is mounted, when the vehicle is positioned inside a calibration room;
generating calibration position information and calibration orientation information for calibration of the vehicle by analyzing the basic position information and the basic orientation information; and
executing calibration on the vehicle sensor on the basis of the calibration position information and the calibration orientation information.

10. The vehicle sensor calibration method of claim 9, wherein the obtaining is performed by any one of a laser scanner and a vision sensor that is installed inside the calibration room.

11. The vehicle sensor calibration method of claim 9, wherein the generating is achieved through an analysis of comparing the basic position information and the basic orientation information with a predetermined calibration pattern.

12. A vehicle sensor calibration method comprising:
obtaining basic position information and basic orientation information of a vehicle on which a vehicle sensor is mounted, when the vehicle is positioned inside a calibration room;
generating calibration position information and calibration orientation information for calibration of the vehicle by analyzing the basic position information and the basic orientation information;
projecting a calibration pattern image that is aligned with the vehicle onto a floor of the calibration room according to the calibration position information and the calibration orientation information;
capturing an image in which the calibration pattern image is aligned with the vehicle; and
executing calibration on the vehicle sensor on the basis of the image obtained in the capturing.

13. The vehicle sensor calibration method of claim 12, wherein the obtaining is performed by any one of a laser scanner and a vision sensor that is installed inside the calibration room.

14. The vehicle sensor calibration method of claim 12, wherein the generating is achieved through an analysis of comparing the basic position information and the basic orientation information with a predetermined calibration pattern.

15. The vehicle sensor calibration method of claim 12, wherein the projecting includes determining an angle of misalignment of the vehicle with respect to a reference direction on the basis of the calibration direction information, and projecting a calibration pattern image on which the determined angle of misalignment is reflected.

16. The vehicle sensor calibration method of claim 12, wherein the projecting includes projecting the calibration pattern image aligned with the vehicle onto the floor of the calibration room using a display panel installed on the floor of the calibration room.

17. The vehicle sensor calibration method of claim 12, wherein the projecting includes projecting the calibration pattern image aligned with the vehicle onto the floor of the calibration room using a projector installed on a ceiling of the calibration room.

18. The vehicle sensor calibration method of claim 12, wherein the projecting includes projecting the calibration pattern image aligned with the vehicle onto the floor of the calibration room by controlling a projector installed on a ceiling of the calibration room so as to be moveable in front-rear and lateral directions and rotatable.
